(19) United States
(12) Patent Application Publication
(10) Pub. No.: US 2025/0296798 A1
(43) Pub. Date: Sep. 25, 2025

(54) MEDIUM GUIDE MECHANISM AND IMAGE FORMING APPARATUS

(71) Applicant: FUJIFILM Business Innovation Corp., Tokyo (JP)

(72) Inventors: Yuki KOHNO, Yokohama-shi (JP); Satoshi WATANABE, Yokohama-shi (JP); Suguru GOTO, Yokohama-shi (JP); Yoshinori KODAKARI, Yokohama-shi (JP); Ryuji KUWATA, Yokohama-shi (JP); Yasuhisa FIKUDA, Yokohama-shi (JP)

(73) Assignee: FUJIFILM Business Innovation Corp., Tokyo (JP)

(21) Appl. No.: 18/774,255

(22) Filed: Jul. 16, 2024

(30) Foreign Application Priority Data
Mar. 25, 2024 (JP) 2024-048747

(51) Int. Cl. B65H 29/60; G03G 15/00; G03G 21/16

(52) U.S. Cl. CPC B65H 29/60; G03G 15/6529; G03G 21/1633

(57) ABSTRACT

A medium guide mechanism includes a pressed member that is pressed by an open-close covering, operable to open or close an opening of a body, in a shift direction of the open-close covering in a state where the open-close covering is shifted to a closing position to close the opening, a contact member that has an orientation thereof fixed by coming into contact with the pressed member in a crossing direction that crosses the shift direction in the state where the open-close covering is shifted to the closing position, and a guiding member that changes an orientation thereof in association with a change in an orientation of the contact member to guide a recording medium that is transported.

### CROSS-REFERENCE TO RELATED APPLICATIONS

This application is based on and claims priority under 35 USC 119 from Japanese Patent Application No. 2024-048747 filed Mar. 25, 2024.

### BACKGROUND

### (i) Technical Field

The present disclosure relates to a medium guide mechanism and an image forming apparatus.

### (ii) Related Art

A sheet-transport-path switching mechanism described in Japanese Unexamined Patent Application Publication No. 2001-39602 includes a branch pawl for switching a sheet transport path in an image forming apparatus, and an open-close covering that is operable to open a portion around the branch pawl for handling jamming. The sheet-transport-path switching mechanism includes a branch pawl support member that supports the branch pawl to allow the branch pawl to swing. The branch pawl support member includes a first axis that supports the branch pawl, and a second axis that rotates the support member separately from or integrally with the open-close covering.

### SUMMARY

A medium guide mechanism includes a pressed member that is pressed by an open-close covering, operable to open or close an opening of a body, in a shift direction of the open-close covering, in a state where the open-close covering is shifted to a closing position to close the opening, and a guiding member that changes an orientation thereof in association with a change in the orientation of the pressed member to guide a recording medium that is transported.

In this structure, when a closing position of the open-close covering varies in a shift direction of the open-close covering, the orientation of the guiding member also varies.

Aspects of non-limiting embodiments of the present disclosure relate to a guiding member that changes an orientation thereof by a smaller amount when the closing position of the open-close covering varies in a shift direction of the open-close covering, than a guiding member that changes an orientation thereof in accordance with a change in orientation of a pressed member pressed in a shift direction of an open-close covering.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium guide mechanism including a pressed member that is pressed by an open-close covering, operable to open or close an opening of a body, in a shift direction of the open-close covering in a state where the open-close covering is shifted to a closing position to close the opening, a contact member that has an orientation thereof fixed by coming into contact with the pressed member in a crossing direction that crosses the shift direction in the state where the open-close covering is shifted to the closing position, and a guiding member that changes an orientation thereof in association with a change in the orientation of the contact member to guide a recording medium that is transported.

### BRIEF DESCRIPTION OF THE DRAWINGS

Exemplary embodiments of the present disclosure will be described in detail based on the following figures, wherein:

FIG. 1 is a schematic structure diagram of an image forming apparatus according to an exemplary embodiment of the present disclosure;

FIG. 2 is a schematic structure diagram of an image forming unit included in an image forming apparatus according to an exemplary embodiment of the present disclosure;

FIG. 3 is a front view of components including guiding members included in a medium guide mechanism according to an exemplary embodiment of the present disclosure;

FIG. 4 is a front view of components including a pressed member and a contact member included in a medium guide mechanism according to an exemplary embodiment of the present disclosure, in a state where an open-close covering is shifted to a closing position;

FIG. 5 is a front view of components including a pressed member and a contact member included in a medium guide mechanism according to an exemplary embodiment of the present disclosure, in a state where an open-close covering is shifted to an open position;

FIG. 6 is a front view of a medium guide mechanism according to a comparative example, to be compared with an exemplary embodiment of the present disclosure, in a state where an open-close covering is shifted to a closing position; and

FIG. 7 is a front view of a medium guide mechanism according to a comparative example, to be compared with an exemplary embodiment of the present disclosure, in a state where an open-close covering is shifted to an open position.

### DETAILED DESCRIPTION

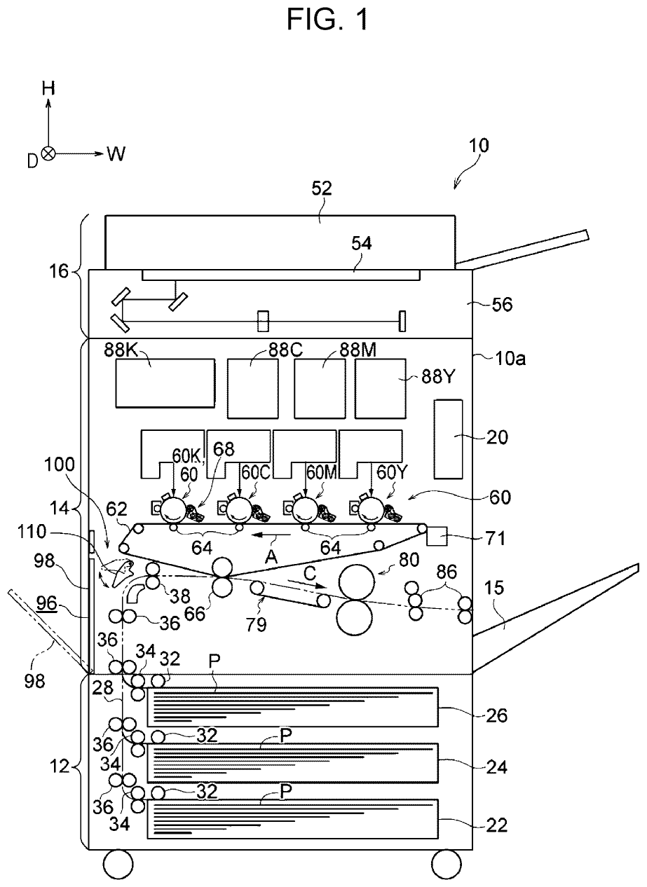

A medium guide mechanism and an image forming apparatus according to one or more exemplary embodiments of the present disclosure are described with reference to FIG. 1 to FIG. 7. Throughout the drawings, arrow H indicates the vertical direction and an apparatus height direction, arrow W indicates the horizontal direction, an apparatus width direction, and a direction orthogonal to arrow H, and encircled cross D indicates the horizontal direction, an apparatus depth direction, and a direction orthogonal to arrow H and arrow W.

### Entire Structure of Image Forming Apparatus

As illustrated in FIG. 1, an image forming apparatus 10 includes, in order from bottom to top, a sheet containing portion 12 that receives recording media P, an image forming portion 14 that is disposed above the sheet containing portion 12 to form images on the recording media P fed from the sheet containing portion 12, a document reader 16 that is disposed above the image forming portion 14 to read a to-be-read document (not illustrated), and a controller 20 that is disposed in the image forming portion 14 to control the operations of these components in the image forming apparatus 10.

### Sheet Container 12

As illustrated in FIG. 1, the sheet containing portion 12 includes a first container 22, a second container 24, and a third container 26 that receive recording media P with different sizes. A pick-up roller 32 is disposed at each of the first container 22, the second container 24, and the third container 26 to transport the recording media P received in the corresponding container to a transport path 28 disposed in the image forming apparatus 10. A pair of transport rollers 34 and a pair of transport rollers 36 are disposed downstream from each pick-up roller 32 in the transport path 28, to transport the recording media P one by one. Registration rollers 38 are disposed downstream from the transport rollers 36 in the transport path 28 in the direction in which the recording media P are transported. The registration rollers 38 temporarily stop the recording media P, and feed the recording media P to a second transfer position described below at predetermined timing.

### Document Reader 16

As illustrated in FIG. 1, the document reader 16 includes a document transport device 52 that automatically transports to-be-read documents one by one, a platen glass 54 that is disposed below the document transport device 52 and receives a single to-be-read document, and a document reading device 56 that reads a to-be-read document transported thereto by the document transport device 52 or a to-be-read document placed on the platen glass 54.

### Image Forming Portion 14

As illustrated in FIG. 1, the image forming portion 14 includes image forming units 60 that each form developer images (toner images), an intermediate transfer belt 62 that is rotatable (circumferentially movable) in a direction of arrow A to carry toner images on its outer circumference, four first transfer rollers 64 that first-transfer toner images formed on the image forming units 60 to the intermediate transfer belt 62, and a second transfer roller 66 that second-transfers toner images on the intermediate transfer belt 62 to the recording media P.

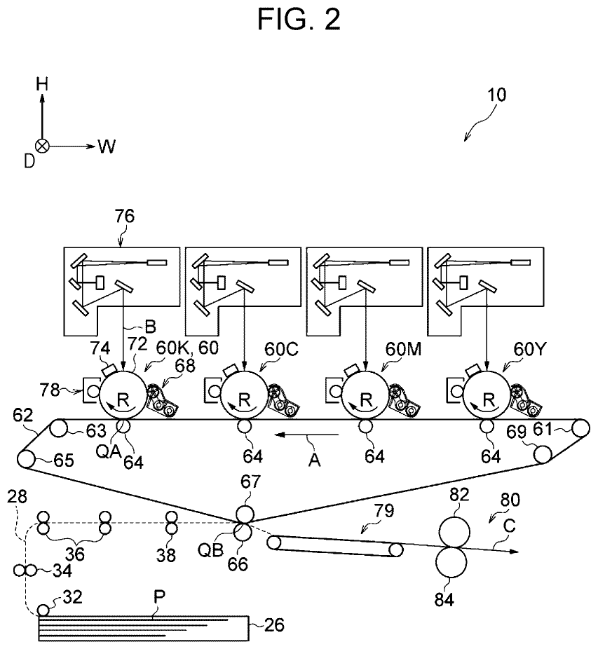

As illustrated in FIG. 2, the image forming units 60 are provided for different colors of toner, and include multiple image forming units 60Y, 60M, 60C, and 60K that respectively form toner images of yellow (Y), magenta (M), cyan (C), and black (K). The image forming units 60Y, 60M, 60C, and 60K differ from one another simply in using toner of different colors, and have the same basic structure. Thus, the image forming unit 60K is described.

In the following description, letters Y, M, C, and K indicating the toner colors may be appended to the reference signs when the toner colors (Y, M, C, and K) are to distinguished, and the reference signs without the letters Y, M, C, and K may be used to describe the components when the toner colors (Y, M, C, and K) are not to be distinguished.

The image forming unit 60K includes an image carrier 72, serving as an example of an image holding member that holds electrostatic latent images and toner images on its outer circumferential surface, a charging unit 74 that charges the outer circumferential surface of the image carrier 72 with electricity, an exposure device 76 that exposes the charged outer circumferential surface of the image carrier 72 to light to form electrostatic latent images on the image carrier 72, a development device 68 that develops the electrostatic latent images formed on the image carrier 72 with toner of the color K to form toner images (of the color K), and a cleaning unit 78 that cleans the outer circumferential surface of the image carrier 72 that has undergone a first transfer.

The image carrier 72 is disposed to oppose the intermediate transfer belt 62, and supported by a driving member (not illustrated) to be rotatable in a direction of arrow R (a circumferential direction and a clockwise direction in the drawings). The charging unit 74 charges the outer circumferential surface of the image carrier 72 with electricity of the polarity the same as the polarity with which toner is charged.

The exposure device 76 emits a laser beam B based on image information to irradiate (expose) the outer circumferential surface of the image carrier 72 charged by the charging unit 74 with (to) the laser beam B to form electrostatic latent images.

The cleaning unit 78 collects toner or dust remaining on the outer circumferential surface of the image carrier 72 that has undergone a first transfer.

The intermediate transfer belt 62 is endless. On the inner surface of the intermediate transfer belt 62, in order from upstream to downstream in the direction of arrow A, a driving roller 61 that moves the intermediate transfer belt 62, the first transfer rollers 64 that first-transfer the toner images on the image carriers 72 to the intermediate transfer belt 62, a support roller 63, a tensioning roller 65, an opposite roller 67 serving as a counter electrode of the second transfer roller 66, and a support roller 69 are disposed to be rotatable in a counterclockwise direction in the drawings.

The intermediate transfer belt 62 is wound around and supported by the driving roller 61, the four first transfer rollers 64, the support roller 63, the tensioning roller 65, the opposite roller 67, and the support roller 69, and circumferentially moves in the direction of arrow A when the driving roller 61 is driven to rotate by a driving member (not illustrated).

In this structure, each first transfer roller 64 first-transfers toner images on the outer circumferential surface of the corresponding image carrier 72 to the intermediate transfer belt 62 at a first transfer position QA. The second transfer roller 66 second-transfers the toner images on the intermediate transfer belt 62 to the recording media P at a second transfer position QB.

A transport unit 79 that transports the recording media P downstream is disposed downstream from the second transfer position QB in the transport path 28. A fixing device 80 is disposed downstream from the transport unit 79 in the transport path 28.

The fixing device 80 includes a heating roller 82 and a pressing roller 84 that presses the recording media P against the heating roller 82. The fixing device 80 fixes the toner images to the recording media P when the recording media P move into a portion (nip portion) where the heating roller 82 and the pressing roller 84 come into contact with each other, to be heated and pressed.

### Operation of Image Forming Apparatus

Subsequently, an image forming operation to be performed by the image forming apparatus 10 is described.

As illustrated in FIG. 2, when the image forming apparatus 10 operates, pieces of image data for yellow (Y), magenta (M), cyan (C), and black (K) are sequentially output to the exposure devices 76 from an image processing device (not illustrated) or an external device.

Subsequently, the outer circumferential surface of each image carrier 72 charged by the corresponding charging unit 74 is exposed to light emitted from the corresponding exposure device 76 in accordance with the piece of image data. Thus, an electrostatic latent image corresponding to the piece of image data of the corresponding color is formed on the outer circumferential surface of the image carrier 72. The electrostatic latent image formed on the outer circumferential surface of the image carrier 72 is developed by the corresponding development device 68 into a toner image of the corresponding color. The toner images of the corresponding colors on the outer circumferential surfaces of the image carriers 72 are first-transferred (transferred in a superposing manner) by the first transfer rollers 64 to the intermediate transfer belt 62.

For example, the recording media P transported from the third container 26 illustrated in FIG. 1 along the transport path 28 are transported to the second transfer position QB by the registration rollers 38 at the timing controlled in consideration of the timing of a superposing transfer of the toner images to the intermediate transfer belt 62. The toner images transferred in a superposed manner onto the intermediate transfer belt 62 are second-transferred by the second transfer roller 66 to the recording media P transported to the second transfer position QB.

The recording media P to which the toner images are transferred are transported in the direction of arrow C (rightward in the drawings) to the fixing device 80. The fixing device 80 fixes the toner images onto the recording media P by heating and pressing the toner images with the heating roller 82 and the pressing roller 84. The recording media P to which the toner images are fixed are transported by transport rollers 86 and discharged to a sheet receiving portion 15 (refer to FIG. 1).

### Structure of Related Portion

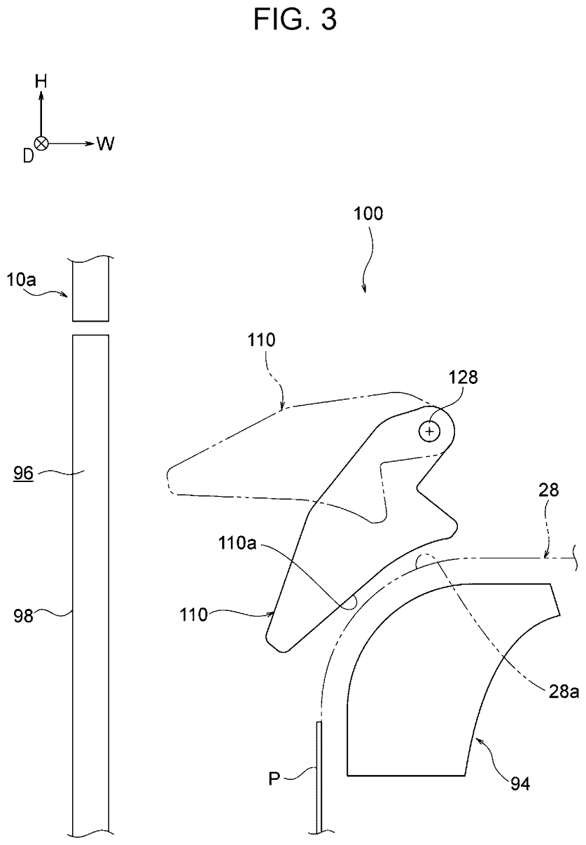

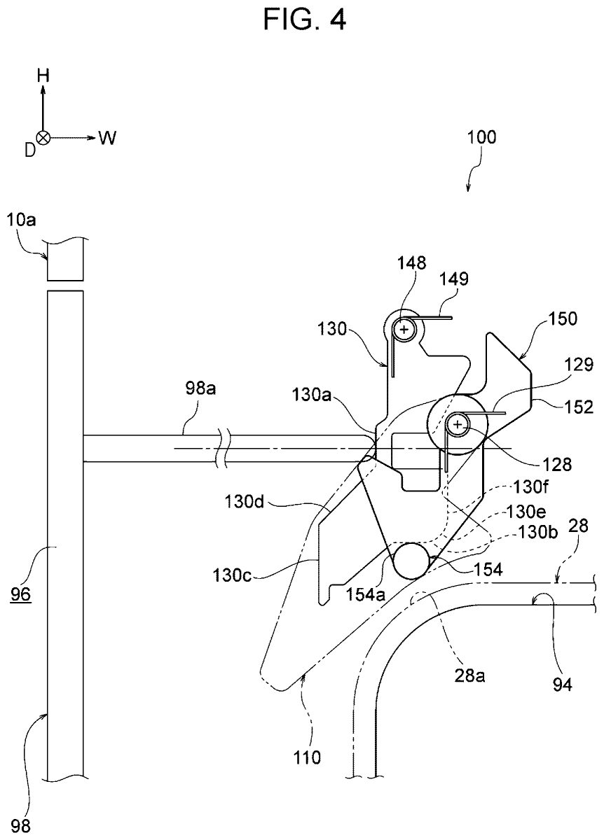

A medium guide mechanism 100 is described now. As illustrated in FIG. 1 and FIG. 3, the medium guide mechanism 100 is disposed at a curved portion 28a of the transport path 28 at which the transport path 28 extending in the height direction is bent to the width direction. More specifically, the medium guide mechanism 100 is disposed at a portion where the direction in which the recording media P are transported is changed. As illustrated in FIG. 3 and FIG. 4, the medium guide mechanism 100 includes guiding members 110 that come into contact with the recording media P to guide the recording media P, a pressed member 130 pressed by an open-close covering 98, and a contact member 150 that comes into contact with the pressed member 130 to have its orientation fixed. More specifically, the open-close covering 98 includes a protrusion 98a that protrudes to the inner portion of a body 10a. The pressed member 130 is pressed by the protrusion 98a of the open-close covering 98.

The open-close covering 98 is attached to the body 10a of the image forming apparatus 10 to be rotatable about the axis extending in the depth direction, to open or close an opening 96 formed in the body 10a on a first side in the width direction (on the left in the drawing).

In this structure, the open-close covering 98 shifts between an open position (two-dot chain line in FIG. 1) to leave the opening 96 open, and a closing position (solid line in FIG. 1) to close the opening 96. In the state where the open-close covering 98 is shifted to the closing position, the medium guide mechanism 100 guides the recording media P along the transport path 28. In contrast, in the state where the open-close covering 98 is shifted to the open position, the medium guide mechanism 100 exposes the curved portion 28a of the transport path 28 to the outside.

### Guide Member 110

As illustrated in FIG. 3, the guiding members 110 shift to a guide position where the guiding members 110 guide the recording media P along the transport path 28 in the state where the open-close covering 98 is shifted to the closing position (solid line in FIG. 3). The guiding members 110 are plates having a plate thickness in the depth direction, and arranged in the depth direction. The multiple guiding members 110 are attached to a shaft 128 extending in the depth direction. More specifically, the multiple guiding members 110 are arranged at predetermined intervals within a range where they oppose the transported recording medium P in the width direction. The depth direction is an example of one direction, and the shaft 128 is an example of a first shaft.

In this structure, the guiding members 110 shift to a guide position to guide the recording medium P along the transport path 28 in the state where the open-close covering 98 is shifted to the closing position (solid line in FIG. 3). In the state where the open-close covering 98 is shifted to the open position, the guiding members 110 rotate about the shaft 128 to shift to the open position to expose the curved portion 28a of the transport path 28 to the outside (two-dot chain line in FIG. 3). The shift of the guiding members 110 is described in detail later.

More specifically, the guiding members 110 in the guide position are located on the outer side of the curved portion 28a of the transport path 28, and have a shape of an isosceles triangle with a recess at a part when viewed in the depth direction. Each guiding member 110 is supported by the shaft 128 at its base end portion to be rotatable about the shaft 128.

Each guiding member 110 is disposed to have its tip portion located on the first side in the width direction and below its base end portion. Each guiding member 110 has a guide portion 110a that is bent into a concave, and that comes into contact with the transported recording media P to guide the recording media P. A guide member 94 having a convexly curved surface is disposed on the inner side of the curved portion 28a of the transport path 28. In other words, the guide member 94 is disposed to oppose the guiding members 110 with the curved portion 28a interposed therebetween.

The guiding members 110 (two-dot chain line in FIG. 3) that have rotated about the shaft 128 and shifted to the open position expose the curved portion 28a of the transport path 28 to the first side in the width direction.

### Pressed Member 130

As illustrated in FIG. 4, the pressed member 130 is disposed on the far side in the depth direction from the multiple guiding members 110.

The pressed member 130 is supported on a shaft 148 extending in the depth direction, and the pressed member 130 is rotatable about the shaft 148. This shaft 148 is disposed along the shaft 128, and, when viewed in the depth direction, disposed above the shaft 128 and on the first side in the width direction from the shaft 128 (on the left in the drawing). In other words, the shaft 128 and the shaft 148 are spaced apart from each other in the width direction. The shaft 148 is an example of a second shaft.

A coil spring 149 (a torsion spring) is attached to the shaft 148, and the coil spring 149 urges the pressed member 130 to rotate clockwise about the shaft 148.

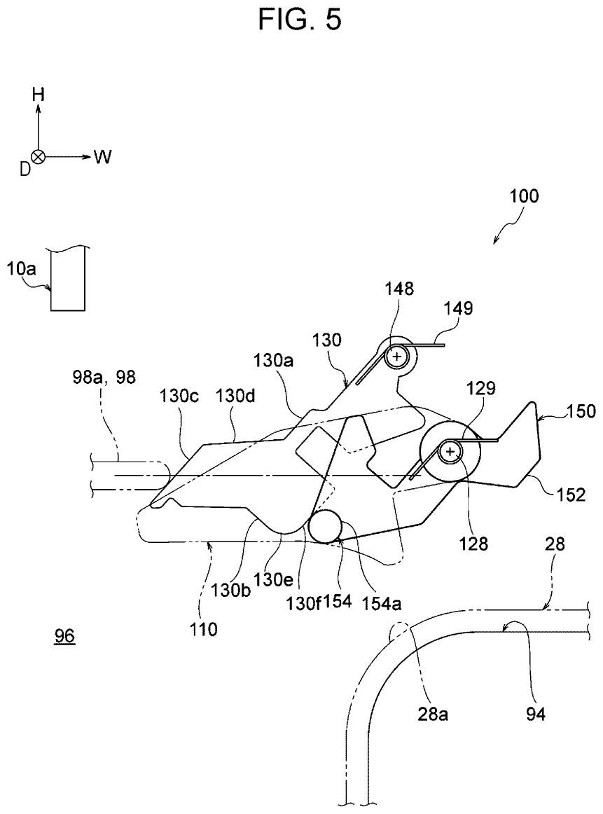

In this structure, the pressed member 130 shifts to a pressed position in which it is pressed by the protrusion 98a of the open-close covering 98 in the state where the open-close covering 98 is shifted to the closing position (refer to FIG. 4). In addition, in the state where the open-close covering 98 is shifted to the open position, the pressed member 130 shifts to a restricted position by being rotated about the shaft 148 by the urging force of the coil spring 149 and being restricted in its rotation by a stopper not illustrated (refer to FIG. 5).

More specifically, as illustrated in FIG. 4, the pressed member 130 in the pressed position extends in the height direction when viewed in the depth direction, and has its upper end portion attached to the shaft 148.

The pressed member 130 has a planar pressed surface 130a pressed by the protrusion 98a of the open-close covering 98. The pressed surface 130a faces toward the first side in the width direction in the state where the open-close covering 98 is shifted to the closing position. The pressed member 130 also has, at a lower portion, a planar contact surface 130b that comes into contact with a circumferential surface 154a of an embossed portion 154, described later, in the height direction. In the state where the open-close covering 98 is shifted to the closing position, the contact surface 130b faces downward. The pressed member 130 also has a planar second surface 130f that is located above and on a second side in the width direction (on the right in the drawing) from the contact surface 130b and connected to the contact surface 130b with an arc-shaped surface 130e interposed therebetween. The second surface 130f faces toward the second side in the width direction in the state where the open-close covering 98 is shifted to the closing position. The contact surface 130b is an example of a contact portion.

As illustrated in FIG. 5, the pressed member 130 has a planar contact surface 130c that first comes into contact with the protrusion 98a of the open-close covering 98 shifting from the open position to the closing position in the state where the pressed member 130 is shifted to the restricted position after being rotated about the shaft 148. As illustrated in FIG. 4, the contact surface 130c faces toward the first side in the width direction in the state where the open-close covering 98 is shifted to the closing position. More specifically, the contact surface 130c is disposed below and on the first side in the width direction from the pressed surface 130a. The pressed member 130 has an inclined surface 130d that connects the contact surface 130c and the pressed surface 130a to each other.

### Contact Member 150

As illustrated in FIG. 4, the contact member 150 is disposed on the far side in the depth direction from the multiple guiding members 110, and disposed on the near side in the depth direction from the pressed member 130.

The contact member 150 is supported on the shaft 128 extending in the depth direction. In other words, the contact member 150 and the multiple guiding members 110 are supported on the shaft 128, and when the contact member 150 rotates about the shaft 128, the guiding members 110 rotate about the shaft 128 together with the rotating contact member 150. In other words, the guiding members 110 change their orientations in association with a change in the orientation of the contact member 150.

A coil spring 129 (a torsion spring) is attached to the shaft 128, and the coil spring 129 urges the contact member 150 to rotate clockwise about the shaft 128.

In this structure, in the state where the open-close covering 98 is shifted to the closing position, the contact member 150 shifts to a positioning position (refer to FIG. 4) at which the contact member 150 comes into contact with the contact surface 130b of the pressed member 130 in the pressed position. In the state where the open-close covering 98 is shifted to the open position, the contact member 150 shifts to a restricted position at which rotation of the contact member 150 is restricted by being rotated about the shaft 128 by the urging force of the coil spring 129 and coming into contact with the second surface 130f of the pressed member 130 in the pressed position (refer to FIG. 5).

More specifically, as illustrated in FIG. 4, when viewed in the depth direction, the contact member 150 in the positioning position extends in an inclination direction or at an inclination with respect to the height direction, and a middle portion of the contact member 150 in the height direction is attached to the shaft 128.

The contact member 150 includes a plate-shaped body portion 152 with a plate thickness in the depth direction, and the embossed portion 154 protruding in the depth direction from the body portion 152.

In this structure, in the state where the open-close covering 98 is shifted to the closing position, the circumferential surface 154a of the embossed portion 154 in the contact member 150 comes into contact with the contact surface 130b of the pressed member 130 in the pressed position in the height direction. Thus, the contact member 150 shifts to the positioning position (refer to FIG. 4). The circumferential surface 154a is an example of a to-be-touched portion.

When the pressed member 130 in the pressed position shifts to the restricted position in the state where the open-close covering 98 is shifted to the open position, the contact member 150 is rotated about the shaft 128 by the urging force of the coil spring 129. The contact member 150 then shifts to the restricted position when the circumferential surface 154a of the embossed portion 154 in the contact member 150 comes into contact with the second surface 130f of the pressed member 130 in the restricted position (refer to FIG. 5).

As described above, the guiding members 110 change their orientations in association with a change in the orientation of the contact member 150. The pressed member 130 in the pressed position thus shifts to the restricted position, and the guiding members 110 in the guide position shift to the open position (refer to FIG. 5).

### Operation of Structure of Related Portion

Subsequently, the operation of the medium guide mechanism 100 involved in opening or closing of the open-close covering 98 is described in comparison with a medium guide mechanism 200 according to a comparative example. First, the structure of the medium guide mechanism 200 according to the comparative example is described in terms of portions that differ from those in the medium guide mechanism 100 according to the present exemplary embodiment.

### Medium Guide Mechanism 200

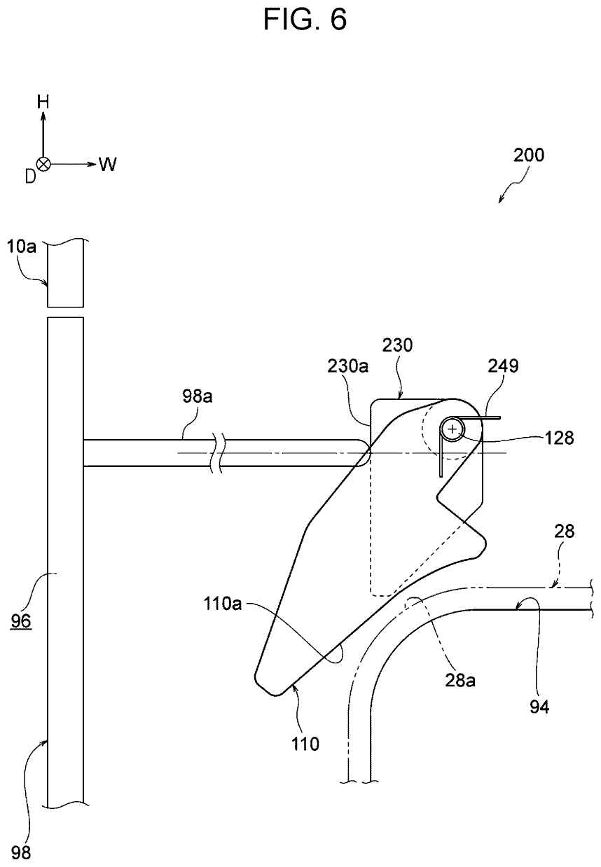

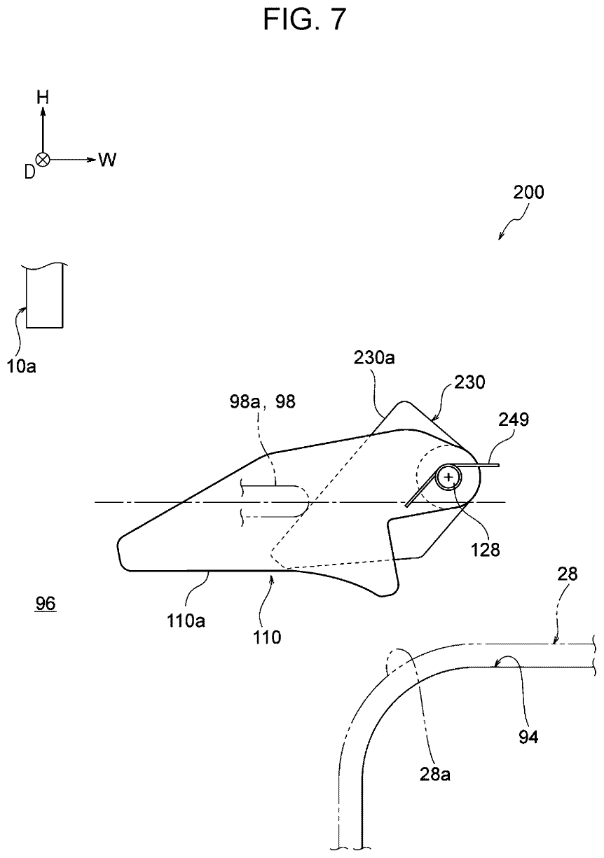

As illustrated in FIG. 6 or FIG. 7, the medium guide mechanism 200 includes guiding members 110 that come into contact with the recording media P to guide the recording media P and that are supported on the shaft 128, and a pressed member 230 that are pressed by the open-close covering 98. The pressed member 230 is disposed on the far side in the depth direction from the multiple guiding members 110.

The pressed member 230 is attached to the shaft 128. A coil spring 249 (a torsion spring) is also attached to the shaft 128. The coil spring 249 urges the pressed member 230 to rotate clockwise about the shaft 128. The guiding members 110 change their orientations in association with a change in the orientation of the pressed member 230.

The pressed member 230 has a planar pressed surface 230a pressed by the protrusion 98a of the open-close covering 98, and the pressed surface 230a faces toward a first side in the width direction in the state where the open-close covering 98 is shifted to the closing position.

In this structure, in the state where the open-close covering 98 is shifted to the closing position, the pressed member 230 shifts to the pressed position at which the pressed member 230 is pressed by the protrusion 98a of the open-close covering 98 (refer to FIG. 6). In addition, in the state where the open-close covering 98 is shifted to the open position, when the pressed member 230 is rotated about the shaft 128 by the urging force of the coil spring 249 and restricted in its rotation by a stopper not illustrated, the pressed member 230 shifts to the restricted position (refer to FIG. 7).

Then, as illustrated in FIG. 6, the pressed member 230 in the pressed position extends in the height direction when viewed in the depth direction, and a portion of the pressed member 230 located at the upper end and on the second side in the width direction is attached to the shaft 128.

When the pressed member 230 shifts to the pressed position, the guiding members 110 shift to the guide position (refer to FIG. 6), and when the pressed member 230 shifts to the restricted position, the guiding members 110 shift to the open position (refer to FIG. 7).

### Operation of Medium Guide Mechanism 100 or 200

—In State where Open-Close Covering 98 is Shifted to Closing Position—

As illustrated in FIG. 4 or FIG. 6, in the state where the open-close covering 98 is shifted to the closing position, the pressed member 130 or 230 shifts to the pressed position in which the pressed surface 130a or 230a is pressed by the protrusion 98a of the open-close covering 98. More specifically, the pressed surface 130a or 230a is pressed by the protrusion 98a in the shift direction of the open-close covering 98. The shift direction of the open-close covering 98 is a direction in which the open-close covering 98 rotating from the open position to the closing position shifts to close the opening 96, and is the width direction in the present exemplary embodiment.

As illustrated in FIG. 6 or FIG. 7, in the medium guide mechanism 200 according to a comparative example, the guiding members 110 change their orientations in association with a change in the orientation of the pressed member 230. In other words, the orientations of the guiding members 110 are changed in association with a change in the orientation of the pressed member 230 pressed in the shift direction of the open-close covering 98.

In the medium guide mechanism 100 according to the present exemplary embodiment, as illustrated in FIG. 4, the circumferential surface 154a of the embossed portion 154 in the contact member 150 comes into contact with the contact surface 130b of the pressed member 130 in the pressed position in the height direction. The height direction is an example of a crossing direction.

The circumferential surface 154a is a curved surface, and the contact surface 130b is a flat surface facing downward. Thus, the contact member 150 changes its orientation by a smaller amount in association with a change in the orientation of the pressed member 130 pressed in the shift direction of the open-close covering 98.

When the circumferential surface 154a of the embossed portion 154 comes into contact with the contact surface 130b of the pressed member 130 in the height direction, the contact member 150 shifts to the positioning position.

In the medium guide mechanism 100, the guiding members 110 change their orientations in association with a change in the orientation of the contact member 150. As described above, the contact member 150 changes its orientation by a smaller amount in association with a change in the orientation of the pressed member 130 pressed in the shift direction of the open-close covering 98. In other words, the guiding members 110 change their orientations by a smaller amount in association with a change in the orientation of the pressed member 130 pressed in the shift direction of the open-close covering 98.

—Operation of Each Component Performed to Shift Open-Close Covering 98 from Closing Position to Open Position—

When the open-close covering 98 in the closing position is shifted to the open position, the pressed member 130 or 230 in the pressed position is rotated clockwise about the shaft 148 or 128 by the urging force of the coil spring 149 or 249, and restricted in its rotation by a stopper not illustrated to shift to the restricted position, as illustrated in FIG. 5 or FIG. 7.

In the medium guide mechanism 200 according to a comparative example, the guiding members 110 change their orientations in association with a change in the orientation of the pressed member 230. In other words, as illustrated in FIG. 6 and FIG. 7, the guiding members 110 shift to the open position in association with a shift of the pressed member 230 to the restricted position.

In the medium guide mechanism 100 according to the present exemplary embodiment, in the process where the pressed member 130 shifts to the restricted position, as illustrated in FIG. 4 or FIG. 5, the contact position between the circumferential surface 154a of the embossed portion 154 and the pressed member 130 is changed. More specifically, after the circumferential surface 154a of the embossed portion 154 that is in contact with the contact surface 130b comes into contact with the arc-shaped surface 130e, and then comes into contact with the second surface 130f, the contact member 150 shifts to the restricted position.

In the medium guide mechanism 100, the guiding members 110 change their orientations in association with a change in the orientation of the contact member 150. In other words, the guiding members 110 shift to the open position in association with a shift of the contact member 150 to the restricted position.

—Operation of Each Component Performed to Shift Open-Close Covering 98 from Open Position to Closing Position—

When the open-close covering 98 in the open position is shifted to the closing position, the pressed surface 130a or 230a of the pressed member 130 or 230 is pressed in the shift direction of the open-close covering 98. Thus, the pressed member 130 or 230 shifts to the pressed position as illustrated in FIG. 4 or FIG. 6.

In the medium guide mechanism 200 according to the comparative example, the guiding members 110 change their orientations in association with a change in the orientation of the pressed member 230. In other words, as illustrated in FIG. 6 or FIG. 7, the guiding members 110 shift to the guide position in association with a shift of the pressed member 230 to the pressed position.

In the medium guide mechanism 100 according to the present exemplary embodiment, in the process where the pressed member 130 shifts to the pressed position, as illustrated in FIG. 4 or FIG. 5, a contact position between the protrusion 98a of the open-close covering 98 and the pressed member 130 is changed. More specifically, when the protrusion 98a of the open-close covering 98 presses the contact surface 130c of the pressed member 130, presses the inclined surface 130d, and then presses the pressed surface 130a, the pressed member 130 shifts to the pressed position.

In the process where the pressed member 130 shifts to the pressed position, as illustrated in FIG. 4 and FIG. 5, a contact position between the circumferential surface 154a of the embossed portion 154 and the pressed member 130 is changed. More specifically, when the circumferential surface 154a of the embossed portion 154 that is in contact with the second surface 130f comes into contact with the arc-shaped surface 130e, and then comes into contact with the contact surface 130b, the contact member 150 shifts to the positioning position.

In the medium guide mechanism 100, the guiding members 110 change their orientations in association with a change in the orientation of the contact member 150. In other words, the guiding members 110 shift to the open position in association with a shift of the contact member 150 to the positioning position.

### Summarization

As described above, in the medium guide mechanism 100, the guiding members 110 change their orientations in association with a change in the orientation of the contact member 150 that has its orientation fixed by coming into contact with the pressed member 130 in the height direction. Thus, compared with the medium guide mechanism 200 according to a comparative example where the orientations of the guiding members are changed in association with a change in the orientation of the pressed member pressed in the shift direction of the open-close covering, the guiding members 110 change their orientations by a smaller amount when the closing position of the open-close covering 98 varies in the shift direction of the open-close covering 98 (the width direction).

In the medium guide mechanism 100, the shaft 128 that supports the guiding members 110 and the contact member 150 is disposed along the shaft 148 that supports the pressed member 130. Thus, unlike in a structure where the shaft that supports the guiding members and the contact member and the shaft that supports the pressed member are coaxial, the pressed member 130 and the contact member 150 easily form different rotation paths and thus effectively come into contact with each other in the height direction.

In the medium guide mechanism 100, the shaft 128 and the shaft 148 are spaced apart from each other in the width direction. Thus, unlike in the structure where the shaft to which the guiding members and the contact member are attached and the shaft to which the pressed member is attached overlap in the width direction, the pressed member 130 and the contact member 150 form greatly different rotation paths, and thus effectively come into contact with each other in the height direction.

In the medium guide mechanism 100, the contact surface 130b of the pressed member 130 that comes into contact with the circumferential surface 154a of the embossed portion 154 in the contact member 150 is a flat surface facing in the height direction. Thus, compared to a structure where the members come into contact with each other at their curved surfaces, the guiding members 110 change their orientations by a smaller amount when the closing position of the open-close covering 98 varies in the shift direction of the open-close covering 98 (the width direction).

In the medium guide mechanism 100, the contact surface 130b of the pressed member 130 that comes into contact with the circumferential surface 154a of the embossed portion 154 in the contact member 150 is a flat surface facing in the height direction, and the circumferential surface 154a of the embossed portion 154 is a curved surface. Thus, compared to a structure where the members come into contact with each other at their flat surfaces, the guiding members 110 change their orientations by a smaller amount when the closing position of the open-close covering 98 varies in the shift direction of the open-close covering 98 (the width direction).

Compared to a structure including the medium guide mechanism 200 according to a comparative example, in the image forming apparatus 10 including the medium guide mechanism 100, the guiding members 110 change their orientations by a smaller amount, and thus less frequently cause jamming of the transported recording media P.

Although the present disclosure is described in detail with reference to a specific exemplary embodiment, the present disclosure is not limited to this exemplary embodiment. It is obvious to persons with ordinary skill in the art that the present disclosure may take various other exemplary embodiments within the range of the present disclosure. For example, in the exemplary embodiment, a medium transport device is included in the image forming apparatus. Instead, the medium transport device may be included in, for example, a preprocessing device for an image forming apparatus, a postprocessing device for an image forming apparatus, a ticket-vending machine that transports and sells tickets, or an automated-teller machine (ATM) that transports and provides or receives banknotes.

When pressed by the open-close covering 98, the pressed member 130 shifts by rotating about the shaft 148, but may shift linearly along, for example, rails. This structure, however, has no effect resulting from the rotational shift of the pressed member.

In the above exemplary embodiment, the shaft 128 and the shaft 148 are spaced apart from each other in the width direction, but do not have to be spaced apart from each other in the width direction. This structure, however, has no effect resulting from these shafts being spaced apart from each other in the width direction.

In the above exemplary embodiment, the pressed member 130 has the planar contact surface 130b facing in the height direction, and the contact member 150 has the circumferential surface 154a of the embossed portion 154 formed from a curved surface that comes into contact with each other. Instead, the pressed member may have a curved surface, and the contact member may have a flat surface that comes into contact with the curved surface of the pressed member.

In the above exemplary embodiment, the open-close covering 98 is a lower hinge, but may be an upper hinge, a side hinge, or a removable hinge.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A medium guide mechanism, comprising:
a pressed member that is pressed by an open-close covering, operable to open or close an opening of a body, in a shift direction of the open-close covering in a state where the open-close covering is shifted to a closing position to close the opening;
a contact member that has an orientation thereof fixed by coming into contact with the pressed member in a crossing direction that crosses the shift direction in the state where the open-close covering is shifted to the closing position; and
a guiding member that changes an orientation thereof in association with a change in an orientation of the contact member to guide a recording medium that is transported.

(((2))) The medium guide mechanism according to (((1))), comprising:
a first shaft that extends in a direction crossing the shift direction and the crossing direction, and that rotatably supports the contact member and the guiding member; and
a second shaft that is disposed along the first shaft, and that rotatably supports the pressed member.

(((3))) The medium guide mechanism according to (((2))),
wherein the first shaft and the second shaft are spaced apart from each other in the shift direction.

(((4))) The medium guide mechanism according to any one of (((1))) to (((3))),
wherein the contact member has a contact portion that comes into contact with the pressed member,
wherein the pressed member has a to-be-touched portion that comes into contact with the contact portion, and
either one of the contact portion and the to-be-touched portion has a flat surface facing in the crossing direction.

(((5))) The medium guide mechanism according to (((4))),
wherein another one of the contact portion and the to-be-touched portion has a curved surface that comes into contact with the flat surface.

(((6))) An image forming apparatus, comprising:
the medium guide mechanism according to any one of (((1))) to (((5))) that guides a recording medium that is transported; and
an image forming portion that forms an image on the recording medium guided by the medium guide mechanism.

What is claimed is:

1. A medium guide mechanism, comprising:
a pressed member that is pressed by an open-close covering, operable to open or close an opening of a body, in a shift direction of the open-close covering in a state where the open-close covering is shifted to a closing position to close the opening;
a contact member that has an orientation thereof fixed by coming into contact with the pressed member in a crossing direction that crosses the shift direction in the state where the open-close covering is shifted to the closing position; and
a guiding member that changes an orientation thereof in association with a change in an orientation of the contact member to guide a recording medium that is transported.

2. The medium guide mechanism according to claim 1, comprising:
a first shaft that extends in a direction crossing the shift direction and the crossing direction, and that rotatably supports the contact member and the guiding member; and
a second shaft that is disposed along the first shaft, and that rotatably supports the pressed member.

3. The medium guide mechanism according to claim 2,
wherein the first shaft and the second shaft are spaced apart from each other in the shift direction.

4. The medium guide mechanism according to claim 1,
wherein the contact member has a contact portion that comes into contact with the pressed member,
wherein the pressed member has a to-be-touched portion that comes into contact with the contact portion, and
either one of the contact portion and the to-be-touched portion has a flat surface facing in the crossing direction.

5. The medium guide mechanism according to claim 4,
wherein another one of the contact portion and the to-be-touched portion has a curved surface that comes into contact with the flat surface.

6. An image forming apparatus, comprising:
the medium guide mechanism according to claim 1 that guides a recording medium that is transported; and
an image forming portion that forms an image on the recording medium guided by the medium guide mechanism.

7. An image forming apparatus, comprising:
the medium guide mechanism according to claim 2 that guides a recording medium that is transported; and
an image forming portion that forms an image on the recording medium guided by the medium guide mechanism.

8. An image forming apparatus, comprising:
the medium guide mechanism according to claim 3 that guides a recording medium that is transported; and
an image forming portion that forms an image on the recording medium guided by the medium guide mechanism.

9. An image forming apparatus, comprising:
the medium guide mechanism according to claim 4 that guides a recording medium that is transported; and
an image forming portion that forms an image on the recording medium guided by the medium guide mechanism.

10. An image forming apparatus, comprising:
the medium guide mechanism according to claim 5 that guides a recording medium that is transported; and
an image forming portion that forms an image on the recording medium guided by the medium guide mechanism.
